(19) United States
(12) Patent Application Publication
(10) Pub. No.: US 2016/0029697 A1
(43) Pub. Date: Feb. 4, 2016

(54) ELECTRONIC SMOKING ARTICLE

(71) Applicant: ALTRIA CLIENT SERVICES LLC, Richmond, VA (US)

(72) Inventor: Kenneth H. SHAFER, Fountain Valley, CA (US)

(21) Appl. No.: 14/772,231

(22) PCT Filed: Mar. 12, 2014
(86) PCT No.: PCT/US2014/024029

§ 371 Date: Sep. 2, 2015

Related U.S. Application Data
(60) Provisional application No. 61/798,966, filed on Mar. 15, 2013.

(51) Int. Cl. A24F 47/00; G05F 1/66

(52) U.S. Cl. CPC A24F 47/008; G05F 1/66

(57) ABSTRACT

An electronic smoking article (100) and a method of preventing unauthorized use of an electronic smoking article (100) are disclosed. The smoking article includes a power supply (120) operable to apply voltage to a heater (144) for heating a liquid; a lock-out feature configured to prevent unauthorized use of the smoking article (100), which disables the power supply to the heater (144) until the lock-out feature is unlocked by an authorized user; a mixing chamber (170) downstream of the heater (144); and at least one air inlet (160) operable to deliver air drawn into the mixing chamber (170), the air being mixed with the volatilized liquid material in the mixing chamber (170) to form an aerosol.

### RELATED APPLICATION(S)

The present application claims priority under 35 U.S.C. 119 to U.S. Provisional Patent Application No. 61/798,966, filed on Mar. 15, 2013, the entire content of which is hereby incorporated by reference.

### WORKING ENVIRONMENT

Electronic smoking articles, such as electronic cigarettes and aerosol generators can include a capillary tube and/or capillary wick designed to deliver liquid material from a liquid reservoir to a heater. Such devices can be activated by a consumer drawing on a mouthpiece to deliver an aerosol to the user.

### SUMMARY

In accordance with an exemplary embodiment, an electronic smoking article is disclosed, the electronic smoking article comprising: a power supply operable to apply voltage to a heater for heating a liquid; a lock-out feature configured to prevent unauthorized use of the smoking article, which disables the power supply to the heater until the lock-out feature is unlocked by an authorized user; a mixing chamber downstream of the heater; and at least one air inlet operable to deliver air drawn into the mixing chamber, the air being mixed with the volatilized liquid material in the mixing chamber to form an aerosol.

In accordance with another exemplary embodiment, a method of preventing unauthorized use of an electronic smoking device is disclosed, the method comprising: disabling a power supply to a heater of an electronic smoking article with a lock-out feature on the smoking article, and wherein the power supply is operable to apply voltage to a heater for heating a liquid to form an aerosol; and enabling the power supply only upon receipt of an activation code from an authorized user, and wherein the activation code unlocks the lock-out feature and enables the power supply to the heater.

### BRIEF DESCRIPTION OF THE DRAWINGS

The disclosure is explained below with reference to the exemplary embodiments shown in the drawings. In the drawings:

FIG. 1 is a cross-sectional view of an electronic smoking article in accordance with an exemplary embodiment having an input activation panel;

FIG. 2 is a cross-sectional view of an electronic smoking article in accordance with an exemplary embodiment having a biometric panel for detecting an authorized user; and

FIG. 3 is a cross-sectional view of an electronic smoking article in accordance with an exemplary embodiment having a proximity or a location based sensor within the smoking article.

### DETAILED DESCRIPTION

In accordance with an exemplary embodiment, a lock-out feature for an electronic smoking article, such as an electronic cigarette is disclosed, which can provide access to the use of the device to only an intended adult smoker and/or owner of the device. In accordance with an exemplary embodiment, the lock-out features can be implemented, which can be easy to learn and operate for the user of the electronic smoking article.

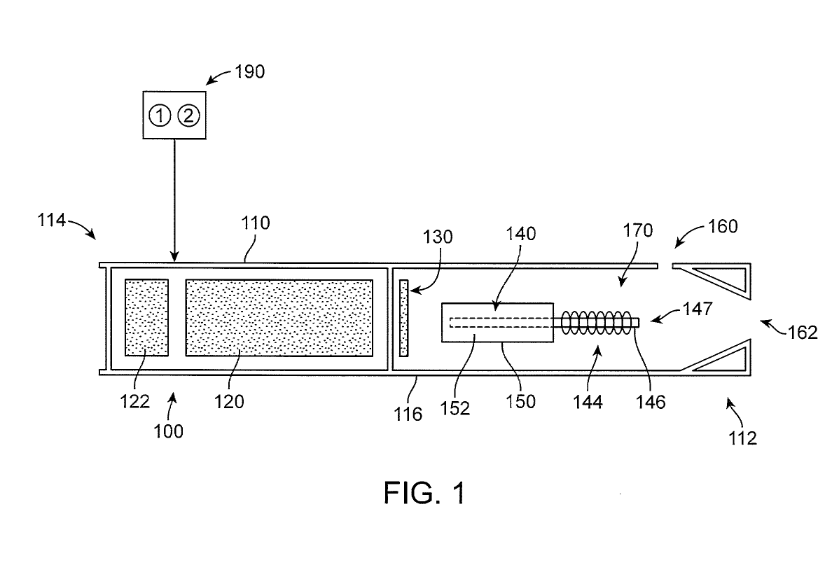

FIG. 1 shows an electronic smoking article 100 in accordance with an exemplary embodiment. As shown in FIG. 1, the electronic smoking article 100 includes a housing 110 having a mouth end 112 and a body end 114. In the body end 114, there is provided an electric power supply in the form of power supply 120 and electric circuitry in the form of circuitry 122 and a puff detection system 130. In accordance with an exemplary embodiment, the detection system 130 can be combined with the circuitry 122 and located an upstream end of the device 100. In the mouth end 112, the smoking article 100 includes a cartridge 140, a heater 144, and a capillary wick (or capillary tube) 146. The cartridge delivers a liquid material 152 from a liquid supply reservoir (or fluid reservoir) 150 to the capillary wick 146, which is surrounded by the heater 144. In accordance with an exemplary embodiment, one end of the capillary wick 146 extends to the cartridge 140 and the other end of the capillary wick 146 is surrounded by the heater 144. The heater 144 is connected to the electric circuitry 122 via connections (not shown). The housing 110 also includes an air inlet 160, an air outlet 162 at the mouth end 112, and an aerosol forming chamber 170.

In use, the liquid material 152 is supplied from the fluid reservoir 150 to the capillary wick 146, which as shown in FIG. 1 is surrounded by the heater 144. When a user draws on the electronic smoking article 100 at the air outlet 162, ambient air is drawn through air inlet 160. In accordance with an exemplary embodiment, the electronic smoking article 100 can include a puff detection system 130, which senses the puff and activates the heater 144 and supplies the liquid material to the capillary wick 146. The power supply 120 supplies pulses of energy to the heater 144 to heat the end of the capillary wick 146 surrounded by the heater 144. The liquid material 152 in the outlet end 147 of the capillary wick 146 can be vaporized by the heater 144 to create a supersaturated vapor. At the same time, the liquid material 152 being vaporized is replaced by addition liquid material 152 moving along the capillary wick 146.

In accordance with an exemplary embodiment, the supersaturated vapor created can be mixed with and carried in the air flow from the air inlet 160. In the aerosol forming chamber 170, the vapor condenses to form an inhalable aerosol, which is carried towards the outlet 162 and into the mouth of the user. The circuitry 122 and the puff detection system 130 are preferably programmable. In accordance with an exemplary embodiment, the circuitry 122 and puff detection system 130 can be used to manage the operation of the electronic smoking article 100.

In use, once the capillary wick 146 is heated, the liquid material contained within a heated portion of the capillary wick 146 is volatilized and ejected out of the outlet 147 where it expands and mixes with air and forms an aerosol in a mixing chamber 170. The electronic smoking article 100 also includes at least one air inlet 160 operable to deliver air to the mixing chamber 170. Preferably, the air inlets 160 to the mixing chamber 170 are arranged downstream of the capillary wick 146 so as to minimize drawing air along the capillary and thereby avoid cooling of the capillary wick 146 during heating cycles.

In use, the volatilized material expands out of the wick 146 and into the mixing chamber 170 where the volatized material can mix with air to form an aerosol which is then drawn through the air outlet 162. In the exemplary embodiment, the at least one air inlet 160 includes one or two air inlets 160. Alternatively, the air inlets 160 can be three, four, or five or more. In accordance with an exemplary embodiment, the size and number of air inlets 160 can also aid in establishing the resistance to draw of the electronic smoking article 100.

In accordance with an exemplary embodiment, the electronic smoking article 100 can include a capillary tube (not shown) rather than a capillary wick 146. The capillary tube has an inlet end in fluid communication with an outlet of the liquid supply reservoir and an outlet end operable to expel volatilized liquid material from the capillary tube. In accordance with an exemplary embodiment, the capillary tube can have an internal diameter of 0.01 to 10 mm, preferably 0.05 to 1 mm, and more preferably 0.05 to 0.4 mm.

The power supply 120 can be a Lithium-ion battery or one of its variants, for example a Lithium-ion polymer battery. Alternatively, the power supply 120 may be a Nickel-metal hydride battery, a Nickel cadmium battery, a Lithium-manganese battery, a Lithium-cobalt battery or a fuel cell. In accordance with an exemplary embodiment, the electronic smoking article 100 is usable by a smoker until the energy in the power supply is depleted. Alternatively, the power supply 120 may be rechargeable and include circuitry (not shown) allowing the battery to be chargeable by an external charging device. For example, the circuitry 122, when charged, provides power for a pre-determined number of puffs, after which the circuitry must be re-connected to an external charging device. The electronic smoking article 100 also includes control circuitry 122, which can be on a printed circuit board. In accordance with an exemplary embodiment, the control circuitry 122 preferably includes memory and an operating system or circuitry, which can be programmed as set forth herein to control access to the electronic smoking article 100.

In accordance with an exemplary embodiment as shown in FIG. 1, the smoking article 100 includes an input activation panel 190. The input activation panel 190 is preferably located on an outer surface 116 of the housing 110 of the smoking article 100 and is configured to receive an activation code from an authorized user of the smoking article 100. In accordance with an exemplary embodiment, the input activation panel 190 is preferably connected to the circuitry 122 of the smoking article 100. The panel 190 can include two or more numbered buttons 192, which can be pressed with a finger, a touch screen pad, or any other suitable panel, which is configured to receive a relatively easy to remember code and can generate a customizable code, which unlocks the smoking article 100.

In accordance with an exemplary embodiment, the customizable code enables the power supply 120 to be activated. Once the electronic smoking article 100 has been enabled, the user can operate the device 100, for example, in accordance with an activation switch (not shown) or a puff detection system 130, which senses the puff, enables the heater 144, and supplies the liquid material 152 to the capillary wick 146.

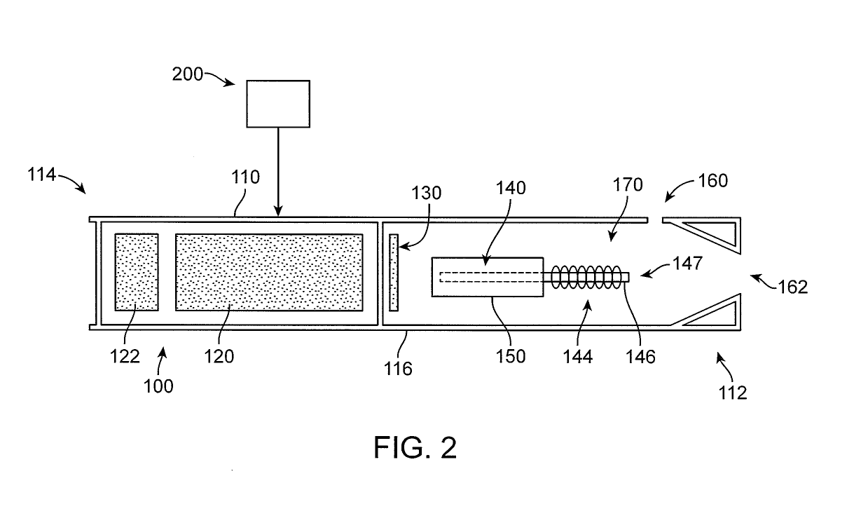

FIG. 2 is a cross-sectional view of an electronic smoking article 100 in accordance with an exemplary embodiment having a biometric panel 200 for detecting an authorized user. In accordance with an exemplary embodiment, the biometric panel 200 detects distinctive and measurable characteristics of an individual, for example, fingerprints and/or voice recognition. In accordance with an exemplary embodiment, the biometric panel 200 is able to detect a user based on a fingerprint, voice or other biometric, and upon said detection unlocks the lock-out feature of the smoking article 100, which enables the power supply 120 within the smoking article 100 to be activated.

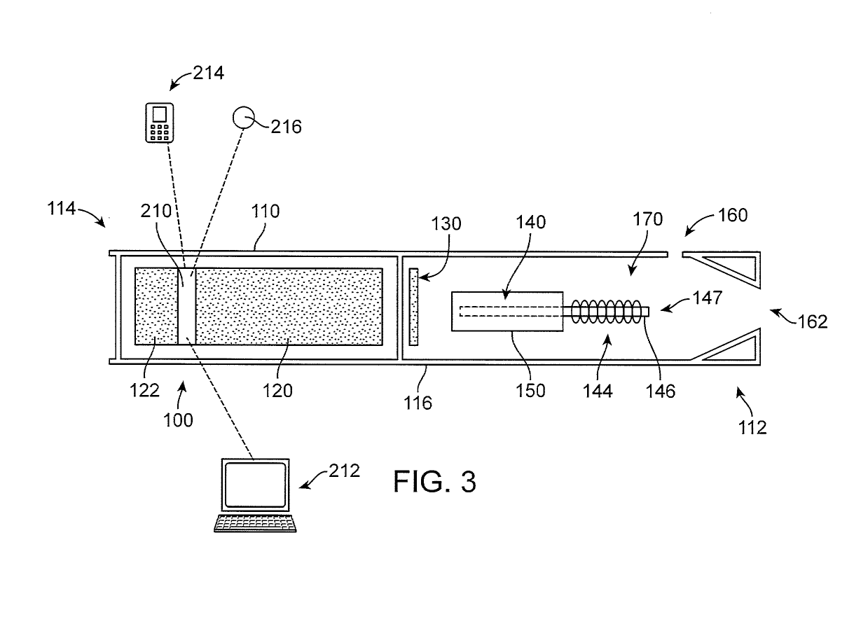

FIG. 3 is a cross-sectional view of an electronic smoking article 100 in accordance with an exemplary embodiment having a proximity or location based sensor 210 within the smoking article 100, which can detect wireless devices 212, for example, hotspots, WiFi at home, favorite coffee shops with wireless access, routers, and/or computers having a computer program (not shown), which can provide access to the sensor 210. In accordance with an exemplary embodiment, the sensor 210 can be configured to detect a corresponding sensor and/or transponder, which is housed, for example, within a wireless device 212, an authorized user's cell phone 214, and/or in a fob 216 (for example, a mechanical device with built-in authentication mechanism). For example, the fob 216 can be on a key chain of an authorized user. The smoking article 100 is preferably configured or programed to unlock and/or enable the power supply 120 within the electronic smoking article 100 upon the detection of the corresponding sensor and/or transponder 212, 214, 216. In accordance with an exemplary embodiment, the corresponding sensor and/or transponder 212, 214, 216 is preferably included within and/or part of a programmable device and/or apparatus 212, 214, 216.

In accordance with an exemplary embodiment, the control circuitry 122 can also include a heater activation light at an upstream end (not shown) operable to glow when the heater 144 is activated. The control circuitry 122 can also include a timer operable to limit the time for which power is supplied to the heater 144. The time-period of the electric current supply to the heater 144 may be pre-set depending on the amount of liquid desired to be vaporized. For example, the control circuitry 122 can be programmable for this purpose.

In accordance with an exemplary embodiment, when enabled, the heater 144 heats a portion of the wick 146 for less than about 10 seconds, more preferably less than about 7 seconds. Thus, the power cycle (or maximum puff length) can range in period from about 1 second to about 10 seconds.

In accordance with an exemplary embodiment, the liquid material 152 includes a tobacco-containing material including volatile tobacco flavor compounds which are released from the liquid upon heating. The liquid material 152 may also be a tobacco flavor containing material or a nicotine-containing material. Alternatively, or in addition, the liquid material 152 may include a non-tobacco material. For example, the liquid material 152 may include water, solvents, ethanol, plant extracts and natural or artificial flavors. Preferably, the liquid material 152 further includes an aerosol former. Examples of suitable aerosol formers are glycerine and propylene glycol.

In an exemplary embodiment, the electronic smoking article 100 is about the same size as a conventional cigarette. In some embodiments, the electronic smoking article 100 can be about 80 mm to about 88 mm long and about 7 mm to about 8 mm in diameter. The outer cylindrical housing 110 of the electronic smoking article 100 may be formed of any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK), ceramic, and polyethylene.

In an exemplary embodiment, the heater 144 can include a coil of wire at least partially surrounding the capillary wick 146. In an exemplary embodiment, the heater 144 is a metal wire and/or a metal alloy wire. The heater 144 can be a coil, which can extend fully or partially along the length of the capillary wick 146.

The electronic smoking article 100 can include a puff indicator (not shown) for indicating when the heater 144 is activated or enabled. In the embodiment in which the electric circuitry 122 includes a sensor to detect air flow indicative of a user taking a puff, the indicator may be activated when the sensor senses air flow indicative of the user taking a puff. In an exemplary embodiment in which the electric circuitry 122 includes a manually operable switch, the indicator may be activated by the switch.

The teachings herein are adaptable to all forms of electronic smoking articles, such as electronic cigarettes, cigars, pipes, hookahs, and other, regardless of their size and shape.

When the word “about” is used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages.

Moreover, when the words “generally” and “substantially” are used in connection with geometric shapes, it is intended that precision of the geometric shape is not required but that latitude for the shape is within the scope of the disclosure. When used with geometric terms, the words “generally” and “substantially” are intended to encompass not only features, which meet the strict definitions but also features, which fairly approximate the strict definitions.

It will now be apparent that a new, improved, and nonobvious electronic smoking article has been described in this specification with sufficient particularity as to be understood by one of ordinary skill in the art. Moreover, it will be apparent to those skilled in the art that numerous modifications, variations, substitutions, and equivalents exist for features of the electronic smoking article, which do not materially depart from the spirit, and scope of the invention. Accordingly, it is expressly intended that all such modifications, variations, substitutions, and equivalents, which fall within the spirit and scope of the invention as defined by the appended claims, shall be embraced by the appended claims.

1. An electronic smoking article comprising:
a power supply configured to apply voltage to a heater for heating a liquid; and
a biometric panel configured to prevent unauthorized vaping of the electronic smoking article and disable the power supply to the heater biometric panel is unlocked by an adult vaper, the biometric panel configured to detect a biometric including one of a fingerprint or a voice print from adult vaper, and upon detection of and adult vaper, enable the power supply.

2-8. (canceled)

9. The electronic smoking article of claim 1, comprising
a capillary wick for holding the liquid; and
wherein the heater is configured to heat the capillary wick to a temperature sufficient to at least initially volatilize the liquid material contained within the capillary wick.

10. The electronic smoking article of claim 1, comprising:
a capillary tube; and
wherein the heater is configured to heat the capillary tube to a temperature sufficient to at least initially volatilize the liquid material contained within the capillary tube.

11. The electronic smoking article of claim 1, comprising:
an outer cylindrical housing extending in a longitudinal direction; and
a liquid material contained within a liquid supply reservoir, which is supplied through an outlet of the supply reservoir into a capillary wick and/or a capillary tube.

12. The electronic smoking article of claim 23, comprising:
a mouth end having at least one outlet, wherein the mouth end is in fluid communication with the mixing chamber so as to deliver an aerosol to an adult vaper; and wherein the power supply includes a battery and the heater is connected to the battery by two spaced apart electrical connections.

13. The electronic smoking article of claim 1, comprising:
control circuitry configured to control supply of power to the heater.

14. The electronic smoking article of claim 10, wherein the at least one air inlet is located upstream of the capillary tube.

15. A method of preventing unauthorized use of an electronic smoking article, comprising:
disabling a power supply to a heater of an electronic smoking article the power supply configured operable to apply voltage to a heater for heating a liquid to form an aerosol; and
enabling the power supply only upon receipt of a biometric activation code by a biometric panel from an adult vaper, the biometric activation code including one of a finger print and a voice print and the biometric activation code detectable by the biometric panel.

16-22. (canceled)

23. The electronic smoking article of claim 1, further including a mixer chamber downstream of the heater; and at least one air inlet configured to deliver air drawn into the mixing chamber, the air being mixed with the volatilized liquid material in the mixing chamber to form an aerosol.
